(19) United States
(12) Patent Application Publication
(10) Pub. No.: US 2022/0373086 A1
(43) Pub. Date: Nov. 24, 2022

(54) VAPOR LEAKAGE COMPACT SEAL

(71) Applicant: NIDEC GPM GMBH, Auengrund OT Merbelsrod (DE)

(72) Inventors: Franz PAWELLEK, Lautertal (DE); Marcel BERNER, Hildburghausen (DE)

(73) Assignee: NIDEC GPM GMBH, Auengrund OT Merbelsrod (DE)

(21) Appl. No.: 17/767,362

(22) PCT Filed: Aug. 6, 2020
(86) PCT No.: PCT/EP2020/072132

§ 371 Date: Apr. 7, 2022

(30) Foreign Application Priority Data
Oct. 8, 2019 (DE) 10 2019 126 971.7

(51) Int. Cl. F16J 15/00; F16J 15/16; F16J 15/3232

(52) U.S. Cl. CPC F16J 15/002; F16J 15/164; F16J 15/3232

(57) ABSTRACT

The invention relates to a shaft seal (1) which is configured to seal a shaft (2) between a coolant side (8) and a dry side (9) in a water pump. The shaft seal (1) is particularly characterized in that a compressible volume compensator (7) for compensating a temperature-dependent volume fluctuation is provided, which is vertically disposed and interacting with the volume of a barrier fluid (6).

The invention relates to a compact seal to prevent vapor leakages which can occur in the event of temperature variations or pressure variations between a liquid medium on the one side and a gaseous medium on the other side of the compact seal, such as e.g. at an opening of a pump shaft in a pump housing.

A shaft seal is subject per se to frictional wear and embrittlement by reason of pressure and temperature variations. It often constitutes the limiting factor in the service life of a pump. In the case of a water pump of a vehicle, the service life of a liquid seal between the delivery flow in a pump chamber and a moisture-sensitive component located downstream thereof, such as a shaft bearing or an electric drive, is of great importance with regard to the operational reliability of a vehicle.

In general, shaft bearings, in particular rolling-element bearings, are sensitive to the ingress of moisture because the materials used, in particular suitable steels of the rolling elements and raceways, are not sufficiently corrosion-resistant for use in moisture. When using shaft bearings in a water pump, the shaft bearing must be protected against the ingress of a coolant leakage from the delivery flow of the water pump. However, small leakages always occur at bearing seals. The occurrence of a coolant leakage leads to the reduction in the surface quality of the rolling elements and raceways as a result of corrosion. Higher friction at the rolling elements can lead to bearing damage by reason of corresponding heat development, which results in a defect in the water pump. Like the shaft bearing, an electric motor used as a pump drive may also need to be protected against the ingress of a coolant leakage from the delivery flow of the water pump, in particular if an electric motor of the dry-runner type is used as a pump drive.

As a rule, conventional shaft bearings, such as e.g. rolling bearings, are sealed by radially acting seals, i.e. sealing washers which are integrated in the shaft bearing. Furthermore, separate sealing arrangements are known from the prior art, whereby an individual adaptation of the sealing property to application-specific pressures and dimensions as well as greater freedom in the selection of bearing types are rendered possible. Such separate seals of pump shafts with respect to static components of a housing are often designed as double lip systems with a small lip spacing. A very small amount of lubricating grease is introduced into the intermediate space as initial lubrication. However, after some time the lubricating grease is used up and a coolant leakage penetrates the intermediate space. The poorer lubricating effect of the coolant leads to increased wear of the sealing lips.

Likewise, solutions are known from the prior art which, in one pump design, provide a drain bore for unavoidable leakages behind the shaft seal. Such a pump design generally includes a leakage chamber arranged below the pump shaft in order to capture an accumulated leakage and allow it to evaporate to the outside, e.g. through a moisture-permeable membrane. However, such structures require a larger installation space for the leakage chamber.

In addition, leakage chambers are only effective to a limited extent against so-called vapor leakages which can occur to the drive side when a liquid delivery medium in the pump chamber heats up and undergoes and increase in pressure. In this case, pressure equalisation is achieved between two axial sides of a shaft seal. In the event of a vapor leakage, gas volumes having a high moisture content pass through the shaft seal during pressure equalisation. In contrast to the liquid droplets of a leakage flow, the fine droplets in the moisture-laden gas volumes cannot settle by gravity at the leakage chamber and can be deposited as condensate on a shaft bearing, located downstream thereof, an electric motor or the like.

Furthermore, the service life of shaft sealing ring depends greatly upon the lubricating conditions at the sealing lip. A dry-running sealing lip or a sealing lip which is lubricated merely by a coolant leakage has a shorter service life than sealing lips in an environment of a lubricating oil-carrying system by reason of the coefficient of friction of the missing lubricating film or a phenomenon explained hereinafter. When sealing lips are lubricated by a coolant, the phenomenon of deposit formation under the dynamic sealing surface of the sealing lip has been observed, which impairs the sealing function over a sustained period. This is caused by leakage drops of a coolant vaporising upon passing through the sealing point and leaving behind crystalline components of the coolant which form a deposit on the shaft.

Accordingly, there is a need for durable sealing solutions for protecting shaft bearings which enable a compact design, especially for compact pump designs, such as coolant pumps in the automotive sector. More precisely, there is a need for shaft seals which, in addition to reliable liquid-sealing, also allow for a compact installation space of the sealing system, i.e. in particular without further constructional measures on the pump structure in addition to the shaft seal.

Patent application DE 10 2018 131 588.0, which was not yet published on the filing date of this patent application and is by the same applicant, relates to such a shaft seal for liquid-sealing of a shaft, preferably in water pumps which are driven by a dry-running electric motor. In the shaft seal, a so-called solid oil is provided as a lubricant reservoir which, in addition to the lubricating function, also fulfils a sealing function between a wet and a dry side.

An object of the present invention is to provide an alternative structure of a durable shaft seal which is developed such that an increased sealing effect to prevent vapor leakages is provided.

The object is achieved by the features of claim 1. The shaft seal is characterized in particular by the fact that a compressible volume compensator, which is arranged such that it interacts with the volume of a barrier fluid, is provided for compensating for a temperature-dependent volume variation.

The invention provides for the first time the use, in a shaft seal, of a compressible volume compensator for compensating for a temperature-dependent volume variation of a barrier fluid.

The compressible volume compensator compensates for an increase in volume of the barrier fluid caused by a rise in temperature. Therefore, a rise in an internal pressure in the shaft seal or a pressure difference between the shaft seal and an outer side of the shaft seal can be limited.

Therefore, the inventive provision of the volume compensator counteracts a loss of the barrier fluid at high operating temperatures as well as a possible entry of vapor leakage by reason of a lost barrier fluid volume during cooling. Furthermore, a volume of the barrier fluid filling, which constitutes a barrier against vapor leakages, is maintained for a long time.

Using a compressible medium, the compressible volume compensator in accordance with the invention represents a reliable and cost-effective way of implementing the desired function and permits a compact design of the volume compensator. The aspect of compact design in turn allows integration of the volume compensator in the shaft seal, i.e. in particular integration of an increased sealing effect to prevent vapor leakages in the shaft seal.

By designing an elastic behaviour of the compressible volume compensator in accordance with the invention, a pressure-dependent function of the volume compensation can be predetermined in a simple manner without a need for regulation and control means and can be optimised to the operating conditions of the application.

The shaft seal takes up little installation space and requires no further constructional safety measures, such as a leakage chamber in the pump structure. Consequently, the shaft seal is suitable for use as a shaft seal which is sealed to prevent vapor leakages, i.e. as a single unit for sealing a pump shaft, in electrically driven water pumps.

By reason of the omission of a leakage chamber, a water pump can be installed in any position. Furthermore, without a leakage chamber, a dimension of the shaft seal can be increased and a volume of the barrier fluid can be dimensioned sufficiently.

Moreover, labyrinth seals or similarly structured seals can be replaced by more favourable shaft seals having a comparatively simply configured sealing lip.

Advantageous developments of the shaft seal in accordance with the invention are the subject matter of the dependent claims.

According to one aspect of the invention, the volume compensator can include a body formed of a compressible material. This configuration makes it possible to achieve position-independent fixing and a relatively temperature-insensitive elastic property of the compressible volume compensator.

According to one aspect of the invention, the compressible volume compensator can be formed as a gas cushion. This configuration makes it possible to provide the volume compensator in particularly simple and cost-effective manner.

According to one aspect of the invention, the barrier fluid can be a lubricating oil or a lubricating grease. By using a lubricant as a barrier fluid, lubrication of the sealing lips of the radial seals on the shaft circumference can be improved and consequently the service life of the shaft seal can be extended. Furthermore, lubricants are cost-effectively available in various application-optimised viscosities.

According to one aspect of the invention, the shaft seal can further comprise a seal casing that includes the primary radial seal, the secondary radial seal, the distance sleeve, the volume of the barrier fluid and the compressible volume compensator. This permits dimensionally stable and flush mounting of the components of the shaft seal independently of a type-specific geometry of a surrounding pump housing or the like, as well as a provision as a unit or assembly.

According to one aspect of the invention, the seal casing can be bent radially inwards to one axial side. This configuration simplifies the mounting of the components of the shaft seal in the seal casing.

According to one aspect of the invention, a seal ring can be respectively arranged between the seal casing and the primary radial seal as well as between the seal casing and the secondary radial seal. In this way, the space taken up by the barrier fluid filling is sealed more effectively to prevent a leakage of the barrier fluid on the part of a static sealing surface of the radial seals.

According to one aspect of the invention, the primary radial seal, the secondary radial seal and the distance sleeve can be fixed inside the seal casing by means of a clamp ring. The clamp ring allows quick and easy mounting of the components of the shaft seal in the seal casing by means of an interference fit or the like.

According to one aspect of the invention, a sealing lip of the primary radial seal and a sealing lip of the secondary radial seal can be formed pointing in the direction of the coolant side in relation to a shaft circumference. This configuration increases a sealing property in relation to the ingress of dirt particles from the coolant side to the inner side as well as in relation to a leakage of the barrier fluid to the air side.

The invention will be described hereinafter with the aid of an exemplified embodiment, applied in a water pump, with reference to the drawing. In the drawing:

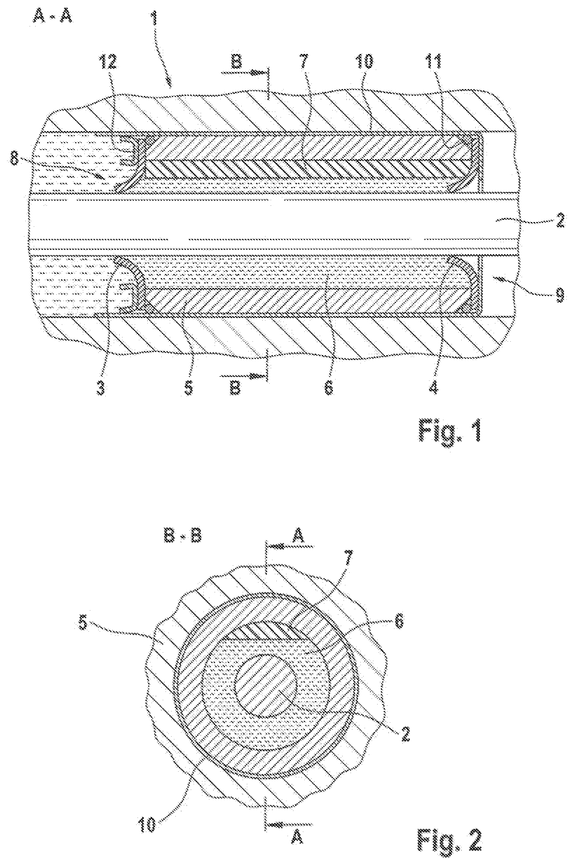

FIG. 1 shows a longitudinal sectional view of the shaft seal according to one embodiment of the invention; and

FIG. 2 shows a cross-section of the shaft seal according to the same embodiment of the invention.

FIG. 1 shows a shaft seal 1 which is used in a pump housing of a water pump, not illustrated, between a pump chamber and a shaft seal and an electric motor. The shaft seal 1 is designed to seal a shaft 2, to be mounted, of the pump between a coolant side 8, which corresponds to a liquid medium, such as cooling water, in a pump chamber, and an air side 9, which corresponds to a drive side with the electric motor. The shaft seal 1 is designed in particular to prevent a liquid medium from passing axially through the shaft seal 1 in the form of a vapor leakage even in the event of a pressure difference between the coolant side 8 and the air side 9.

The shaft seal includes a seal casing 10, a primary radial seal 3 to the coolant side 8, a secondary radial seal 4 to the air side 9, a seal-effective barrier fluid 6 filling and a compressible volume compensator 7.

The seal casing 10 fixes the primary radial seal 3 and the secondary radial seal 4 relative to one another and holds the included volume of the barrier fluid 6. The seal casing 10 has a cylindrical shell which includes, at an axial end directed to the air side 9, a one-sided bend towards a radial inner side. An open cross-section is provided on the seal casing 10 to the coolant side 8, through which, inter alia, the radial seals 3, 4, are introduced and mounted.

The radial seals 3, 4, form a static sealing surface to the seal casing 10 and a dynamic sealing surface in the form of a sealing lip to the circumference of the shaft 2. The sealing lip of the primary radial seal 3 is inclined axially towards the outer side of the shaft seal 1, i.e. towards the coolant side 8, and the sealing lip of the secondary radial seal 4 is inclined axially towards the inner side of the shaft seal 1.

The secondary radial seal 4 is fixed against the bend of the seal casing 10 by means of an axial restriction. A distance sleeve 5 which is inserted into the seal casing 10 defines a distance between the secondary radial seal 4 and the primary radial seal 3. A clamp ring 12 which is finally inserted into the seal casing 10 fixes the primary radial seal 3 against the distance sleeve 5 by means of an axial restriction. Furthermore, seal rings 11 are arranged between the axial ends of the distance sleeve 5 and the radial seals 3, 4 and additionally seal the radially outer, static sealing surfaces of the radial seals 3, 4 against the seal casing 10. In the shaft seal 1, a compressible volume compensator 7 is arranged between the primary radial seal 3 and the secondary radial seal 4 over the axial extension of the distance sleeve 5.

A space remaining in the seal casing 10 between the primary radial seal 3 and the secondary radial seal 4 and to a contact surface of the compressible volume compensator 7 is completely taken up by the volume of the barrier fluid 6. In the present embodiment, a lubricating oil, e.g. consisting of a synthetic hydrocarbon, a silicone oil, an ester oil or the like, of which the viscosity is preferably higher than the viscosity of the coolant on the coolant side 8, is used for the barrier fluid 6. The barrier fluid 6 effects hermetic sealing of the shaft seal 1, because the volume of the barrier fluid 6 introduced is in contact with the shaft circumference of the primary radial seal 3 and the secondary radial seal 4. Furthermore, the barrier fluid 6 lubricates the sealing lip of the primary radial seal 3 on the coolant side 8 and the sealing lip of the secondary radial seal 3 on the air side 8.

As illustrated in FIG. 2, the compressible volume compensator 7 has a prismatic shape with a convexly curved surface and a planar surface which extend substantially in parallel with the shaft 2. The curved surface of the volume compensator 7 is congruent with an inner surface of the cylindrical jacket of the seal casing 10. The planar surface of the volume compensator 7 lies radially inwards from the curved surface and closes off the body of the volume compensator 7 at edges of the convex curvature which extend in parallel.

In the present embodiment, the compressible volume compensator 7 consists of a flexible, non-sorptive material. Preferably, the body of the compressible volume compensator 7 is produced from a cellular rubber, such as a foamed, closed-cell elastomer. Elastomers or cellular rubber have a suitable elasticity to be compressed by a thermal expansion of the volume of the barrier fluid 6 in contact therewith. In addition, foamed elastomers are cost-effectively available in various degrees of hardness. The closed-cell structure prevents the elastomer from becoming saturated with the barrier fluid like a sponge and consequently from becoming almost incompressible.

During the operation of the water pump, not illustrated, in which the shaft seal 1 is arranged, a coolant conveyed by the water pump is heated by an internal combustion engine, an electric traction motor or the like. The coolant heats the pump housing and finally the shaft seal 1 and the barrier fluid 6. This is associated with an increase in volume of the barrier fluid 6 or a rise in pressure in the shaft seal 1. As a result of the compressibility of the body or the medium which forms the compressible volume compensator 7, a rising internal pressure in the shaft seal 1 by reason of the temperature-dependent volume change of the barrier fluid 6 is limited. However, compressibility is set in such a way that the temperature-dependent internal pressure in the shaft seal 1 is at least greater than a temperature-dependent vapor pressure of the coolant during operation. A pressure difference between the higher internal pressure in the shaft seal 1 compared to the coolant side 8 is preferably set to up to 1 bar. Such a range of pressure differences can be absorbed by the primary radial seal 3 in the long term without any adverse effects.

By compensating for an increase in volume, a leakage of the barrier fluid 6 or a long-term loss of the barrier fluid 6 filling caused by numerous rises in pressure in the shaft bearing 1 is prevented. On the other hand, since there is a positive pressure difference between the barrier fluid 6 in the shaft seal 1 and the coolant side 8, no leakages of the coolant into the shaft bearing 1 are instigated. A suitable viscosity of the barrier fluid 6 which is preferably higher than that of the coolant, suppresses diffusion of bubbles under the vapor pressure of the coolant and thus a corresponding migration of bubbles of a gaseous vapor leakage of the coolant into or through the shaft seal 1. Furthermore, the pressure of the barrier fluid 6 in the shaft seal 1 leads to an optimised hydrodynamic lubrication of the sealing lip of the secondary radial seal 4, which runs almost in a wear-free manner on the air side 9 of the dry-running electric motor of the water pump.

In the illustrated embodiment, a modulus of elasticity of a closed-cell, foamed elastomer for the compressible volume compensator 7 and a ratio of the body volume thereof to the volume of the barrier fluid 6 are selected in dependence upon parameters including a specific volume change of the barrier fluid 6, a temperature difference of an operating temperature range of the coolant, and a path and a partial force along a displacement of a volume boundary surface between the volume compensator 7 and the barrier fluid 6.

The barrier fluid 6 is further selected according to a property that a temperature-dependent vapor pressure of the barrier fluid 6 within the operating temperature range of the coolant is lower than an air pressure on the air side 9. Therefore, a vapor leakage to the air side 9 is prevented.

As an alternative to the illustrated embodiment, the inventive shaft seal 1 having the sealing arrangement can be produced in different embodiments which likewise correspond to the core of the invention and are part of the disclosure below.

In an alternative embodiment which can be produced in a particularly simple and favourable manner, the body of the compressible volume compensator 7 is formed from a gas cushion or an air cushion which remains confined in a space above the volume of the barrier fluid 6 and between the inner surface of the cylindrical jacket of the seal casing 10 and the radial seals 3, 4. The gas cushion likewise demonstrates a suitable compressible behaviour in the range of the operating temperatures, which can be used to compensate for volume variations of the barrier fluid 6, i.e. in particular to compensate for an increase in volume of the barrier fluid 6 brought to operating temperature.

In further alternative embodiments, the compressible volume compensator 7 can have a shape other than a prismatic shape. For example, the compressible volume compensator 7 can be formed of an annular body or any one-piece shape of a compressible medium. Likewise, the compressible volume compensator 7 can be provided from a plurality of bodies or a particulate distribution of spherical or other small bodies of compressible medium within the barrier fluid 6 filling.

Furthermore, in an alternative embodiment, the shaft seal 1 in accordance with the invention can be produced without the seal casing 10. In this case, the components of the shaft seal 1 are successively inserted and fixed in a housing portion of a pump or a surrounding system, wherein a space which is taken up by the volume of the barrier fluid 6 is formed between the components of the shaft seal 1 in the surrounding housing portion or system.

### LIST OF REFERENCE NUMERALS

1 shaft seal
2 shaft
3 primary radial seal
4 secondary radial seal
distance sleeve
6 barrier fluid
7 compressible volume compensator
8 coolant side
9 air side
seal casing
11 seal ring
12 clamp ring

1. A shaft seal configured to seal a shaft between a coolant side and a dry side in a water pump comprising:
a primary radial seal for sealing a shaft circumference to the coolant side;
a secondary radial seal for sealing the shaft circumference to the dry side;
a distance sleeve extending between the primary radial seal and the secondary radial seal; and
a barrier fluid, wherein a volume of the barrier fluid takes up a space between the primary radial seal and the secondary radial seal;
wherein
a compressible volume compensator arranged such that it interacts with the volume of the barrier fluid is provided for compensating a temperature-dependent volume variation.

2. The shaft seal according to claim 1, wherein the compressible volume compensator includes a body formed of a compressible material.

3. The shaft seal according to claim 1, wherein the compressible volume compensator is formed as a gas cushion.

4. The shaft seal according to claim 1, wherein
the barrier fluid is a lubricating oil or a lubricating grease.

5. The shaft seal according to claim 1, further comprising
a seal casing that includes the primary radial seal, the secondary radial seal, the distance sleeve, the volume of the barrier fluid and the compressible volume compensator.

6. The shaft seal according to claim 5, wherein the seal casing is bent radially inwards to one axial side.

7. The shaft seal according to claim 5, wherein
a seal ring is respectively arranged between the seal casing and the primary radial seal as well as between the seal casing (10) and the secondary radial seal.

8. The shaft seal according to claim 5, wherein
the primary radial seal, the secondary radial seal and the distance sleeve are fixed inside the seal casing by means of a clamp ring.

9. The shaft seal according to claim 1, wherein
a sealing lip of the primary radial seal and a sealing lip of the secondary radial seal are formed pointing in the direction of the coolant side relative to a shaft circumference.
